(19) United States
(12) Patent Application Publication
(10) Pub. No.: US 2007/0019568 A1
(43) Pub. Date: Jan. 25, 2007

(54) Method of monitoring network elements supporting virtual private networks

(75) Inventor: Manivannan Velupillai, Hoffman Estates, IL (US)

Correspondence Address: BROOKS KUSHMAN P.C., 1000 TOWN CENTER, TWENTY-SECOND FLOOR, SOUTHFIELD, MI, 48075, US

(73) Assignee: SBC Knowledge Ventures, L.P., Reno, NV (US)

(21) Appl. No.: 11/188,179

(22) Filed: Jul. 22, 2005

(51) Int. Cl. H04L 12/28; H04L 12/56

(52) U.S. Cl. 370/254; 370/401

(57) ABSTRACT

A method of monitoring network elements configured to support a number of customer virtual private networks (VPNs) provided for a number of customers. The method comprising associating network addresses and extended community numbers (ECNs) with the network elements; associating the ECNs with a number of the customer VPNs; generating a community list for at least a selected one of the customer VPNs, the community list specifying the network addresses for the network elements associated with the ECN of the selected customer VPN; contacting the network elements specified in the community list based on the network addresses associated therewith and extracting VPN interface information for the contacted network elements, the VPN interface information specifying a number of VPN interfaces associated with the network element and the customer associated with the VPN interfaces; and determining an interface status for the interfaces associated with the selected customer.

### BACKGROUND OF THE INVENTION

1. Field of the Invention

The present invention relates to methods of monitoring network elements used to support virtual private networks.

2. Background Art

Virtual private networks (VPNs) are private networks supported with public or non-private network elements. The VPN permits a user to utilize the network without the user being aware that a shared network are used to support the operation thereof. In some cases, the network elements are required to support operations associated with different VPNs. For example, a router may be required to support operations associated with a number of different VPNs.

One problem faced by the internet service providers (ISPs) or other providers of such VPNs relates to the ability of the VPNs to control some of the protocols, addressing nomenclature, and other features associated with their VPN. With multiple VPNs being supported on common network elements, and the ability of the VPN customers to control the operation thereof, it can be difficult for the providers to monitor the operation of the network elements.

### BRIEF DESCRIPTION OF THE DRAWINGS

FIG. 1 illustrates a system having multiple virtual private networks (VPNs) in accordance with one non-limiting aspect of the present invention;

FIG. 2 illustrates flowchart of a method of monitoring the network elements in accordance with one non-limiting aspect of the present invention;

FIG. 3 illustrates an exemplary composite report in accordance with one non-limiting aspect of the present invention; and

FIG. 4 is a diagrammatic representation of a machine in accordance with one non-limiting aspect of the present invention.

### DETAILED DESCRIPTION OF THE PREFERRED EMBODIMENT(S)

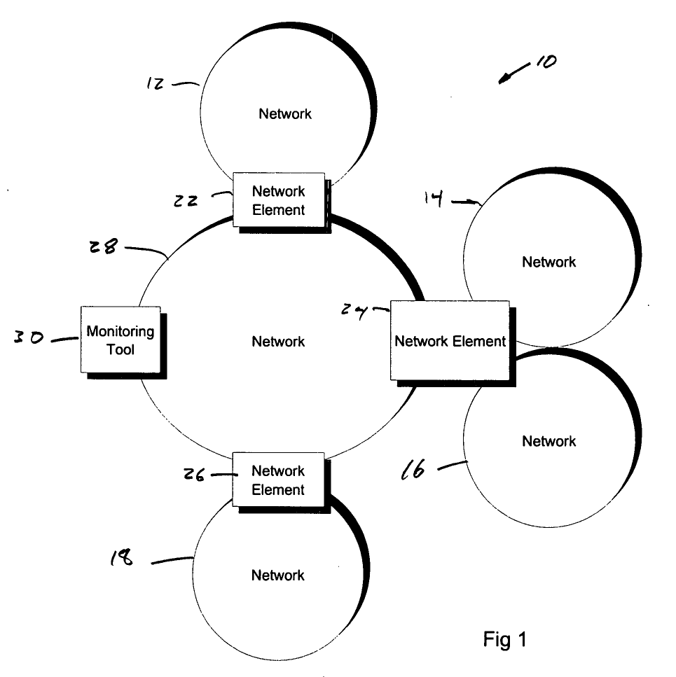

FIG. 1 illustrates a system 10 having multiple virtual private networks (VPNs) 12-18 in accordance with one non-limiting aspect of the present invention. The system 10 includes a number of network elements 22-26 to support the VPNs 12-18. The network elements 22-26 communicate with a service provider network 28 or other backbone infrastructure to facilitate communications between the network elements 22-26 and a monitoring tool 30 configured to monitor the operations thereof.

The network elements 22-26 may be provided and supported by an internet service provider, a telecommunications provider, or other entity sufficiently configured to provide electronic data services to customers. For example, the network elements 22-26 may be configured to support terrestrial or extraterrestrial, wireline and/or wireless networks, or some combination thereof, and include routers, bridges, gateways, switches, soft switches, and other features associated with supporting network operations.

The VPNs 12-18 generally relate to private networks supported with shared or non-private network elements. Multiple VPNs 12-18 may be supported on the same network elements 22-26. The system 10 is shown for exemplary purposes and is not intended to limit the scope and contemplation of the present invention. The present invention fully contemplates any number of environments where one or more network elements 22-26 may be configured to support one or more VPNs 12-18. In particular, the present invention contemplates environments where the monitoring tools is configured to monitor numerous network elements 22-26 provided to support any number of VPNs 12-18.

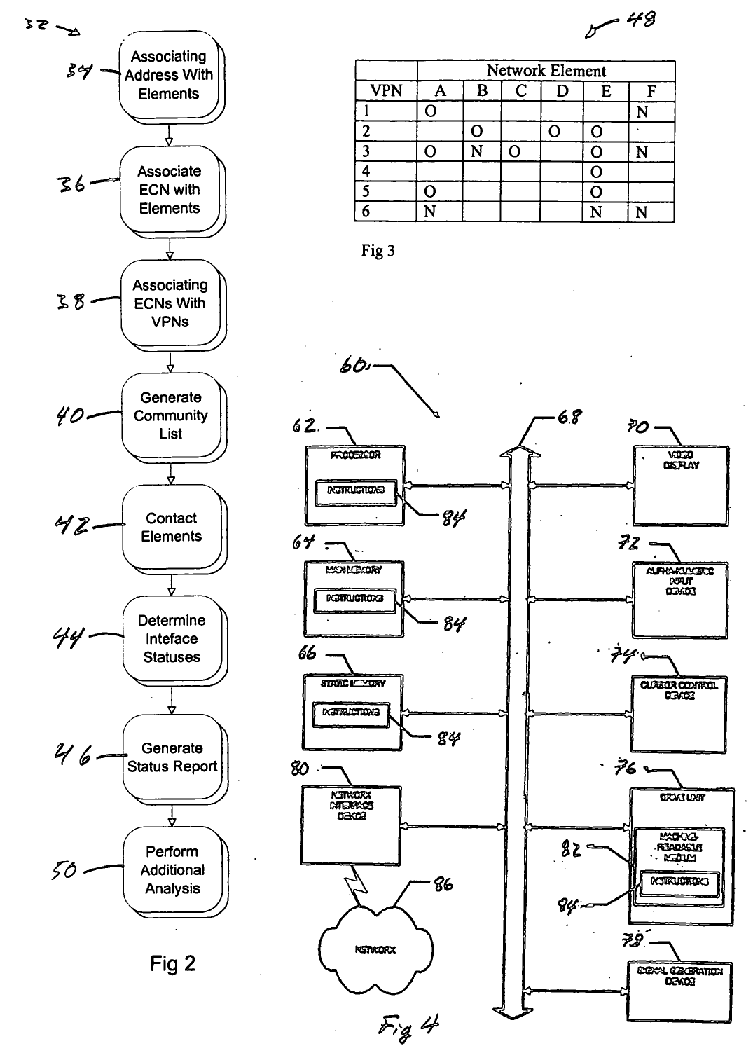

FIG. 2 illustrates flowchart 32 of a method of monitoring the network elements in accordance with one non-limiting aspect of the present invention. The method may be embodied in a computer-readable medium or other logically functioning element for execution by a computer or other feature associated with the monitoring tool. Any number or protocols, operations, and other functions may be executed by the tool to facilitate the operations expressed below. The method generally relates to monitoring operations of network elements used to support multiple virtual private networks (VPNs).

Block 34 relates to associating extended community numbers (ECNs) with the VPNs 12-18. For example, multiple VPNs 12-18 may be associated with multiple customers, with some customers having multiple VPNs 12-18. Each of these customer VPNs 12-18 may be assigned an ECN for uniquely identifying the VPN 12-18 from the other VPNs 12-18. Some customers may be associated with multiple ECNs if the customer has multiple VPNs 12-18, i.e., an ECN may be assigned for each customer VPN 12-18.

Preferably, each ECN is a unique identifier that uniquely identifies each ECN from the other ECNs. Optionally, additional identifiers may be associated with the ECNs to identify the customers associated therewith. This is useful with customers having multiple VPNs 12-18 in order to identify the customer and the ECNs associated therewith. The ECN and customer identifiers may be determined by a system operator or generated by the monitoring tool. The values associated therewith are stored in a database or other memory location, such a in a look-up table or a relational database associated with the monitoring tool 30 or otherwise in communication therewith.

Block 36 relates to associating network addressing information with the network elements 22-26. The network addressing information relates to addressing information required to electronically communicate with the network elements 22-26, such as commonly used internet protocol (IP) addresses and media access control (MAC) addresses. The network addressing information is preferably sufficient for the monitoring tool 30 to establish communications with the various network elements and to provision, control, or otherwise direct or facilitate directing the operation thereof.

The network addressing information may be inputted to the monitoring tool 30 by the system operator and/or extracted from a provisioning database. For example, the service provider may include a trunk integrated record keeping system (TIRKS) or other provisioning database which tracks each network element 22-26 and the addressing information associated therewith. Commonly, such provisioning databases are populated when configuring the VPNs 12-18 for each customer, i.e., when a customer purchases a VPN 12-18, a system operator other individual must determine the network elements 22-26 which will support the operation thereof. The network elements 22-26 and information associated therewith, such as network addressing information, may be entered into the provisioning database and related to the VPN 12-18 associated therewith.

Block 38 relates to associating the ECNs with the network elements 22-26 used to support the VPNs 12-18 associated therewith. This requires the monitoring tool to cross-reference or otherwise correlate the ECNs generated in block 36 with the network addressing information generated in block 34. This association allows the monitoring tool 30 to use the ECN to identify each network element 22-26 associated with the particular customer VPN 12-18 and to identify communications information for communicating with the network elements 22-26 associated therewith.

Block 40 relates to generating a community list for a selected one of the customer VPNs 12-18. The community list relates to a listing of network elements 22-26 and addresses associated with a selected VPN 12-18. The community list may be generated in response to a system operator inputting an ECN for a selected VPN and the monitoring tool 30 correlating the ECN with the information collected in blocks 34-38.

Block 42 relates to the monitoring tool contacting each network element 22-26 listed in the community list. This may include the monitoring tool 30 communicating with the network elements 22-26 to determine interface information associated with the operation thereof. The interface information relates to the interfaces on each network element 22-26 and the circuits or other features connected thereto. A memory or other storage feature on the network elements 22-26 may include an interface map listing the interfaces supported by the network element 22-26 and an identifier of the VPN 12-18 and/or customer associated therewith.

The monitoring tool 30 may be configured to retrieve the interface information by broadcasting a message to each of the network elements 22-26 included within the community list. The message may include instructions for instructing the network elements 22-26 to reply with the interface information associated therewith. The tool 30 may then decipher the received interface information to locate the interfaces associated with the selected VPN 12-18.

In more detail, the interface information may list each interface supported on the associated network element as function of the customer associated therewith. The monitoring tool 30 may cross-reference the customers indicated in the interface information with the customer associated with the selected VPN 12-18. If the customer includes multiple VPNs 12-18 on the same network element 22-26 such that the interface information indicates the same customer for multiple interfaces, the monitoring tool may further parse the information based some other identifiers associated with the selected VPN 12-18, such as its ECN.

Block 44 relates to the monitoring tool determining interface statuses for each interface associated with the selected VPN 12-18. The interface status may relate to the operation status of the interface, i.e., whether the interface is communicating with the other interfaces of the other network elements 22-26 used to support the selected VPN 12-18. This may include the monitoring tool 30 pinging the interfaces to determine whether the interfaces are communicating properly with the other interfaces. The interface information may further include interface addressing information or other information related to identifying and locating the interfaces within the network element 22-26 to facilitate determining the status thereof.

Block 46 relates to generating a status report for indicating the interface statuses for the selected VPN 12-18. The report may generally indicate which interfaces are operating properly and which ones are not. The report may be useful in diagnosing communicating difficulties of the VPN 12-18. For example, if the customer reports an error in the VPN 12-18, the service operator may request the report to determine whether the interfaces associated with the desired VPN 12-18 are operating properly.

Optionally, the status report may relate to a composite interface status report for multiple VPNs 12-18. The composite report may be used to indicate operations associated with multiple customers and/or multiple VPNs 12-18 of one or more customers. The report may also be used to determine operations statuses for multiple network elements 22-26 on a logical level. FIG. 3 illustrates an exemplary composite report 48 in accordance with one non-limiting aspect of the present invention.

The composite report 48 may be used to indicate operational status for the interfaces associated with a number of VPNs 12-18 and a number of network elements 22-26 used to support the operation thereof. An ‘O’ designation may be used to indicate proper operation of the interface and a ‘N’ designation may be use to indicate improper operation of the interface, of course, any number of other indicator and/or color designations may be used.

As shown, the report 48 provides an operational snapshot which can be used by a system operator to quickly diagnosis problem locations. This may be helpful in assisting the system operator in locating the source of operating difficulties so that the problem may be more quickly located and corrected.

The system operator may quickly ascertain that network element F is completely inoperable as each interface associated therewith is operating improperly, indicating that there may be a global or physical problem with the network element 22-26. The system operator may determine a logical problem with the operation of network element B due to the fact that the same router is functioning properly with respect to another VPN 12-18 supported on the same network element (VPN 2). The system operator may determine a logical and physical problem for VPN 6 as each network element associated therewith is inoperable—a logical problem is determined because of the network elements A and E being operable with other VPNs 12-18 and physical problem is determined because network element is inoperable with all other VPNs 12-18.

Block 50 relates to perform additional analysis for one or more of the selected VPNs 12-18. The additional analysis may include performing an operation security check for one or more customers. The operation security check may be used to verify each network element associated with a particular VPN 12-18. For example, the interface information retrieved in block may be compared to a previous set of interface information to determine whether any changes have occurred thereto, such as to determine if more or less interfaces have been associated wit the VPN 12-18. This analysis may be used to determine whether system operators have accidentally removed or added an interface from the VPN 12-18, such as by incorrectly provisioning the operation thereof.

Optionally, the monitoring may be configured to perform the foregoing analysis and to output alerts are other warnings signals as function thereof. In this manner, the monitor may be able to isolate logical from physical problems and to advise a system operator of the network elements 22-26 associated therewith. The system operator can then communicate with the network elements 22-26 based on the collected addressing information to isolate the problem, such as by retrieving the configurations profile or other management profile and inspecting the contents thereof.

FIG. 4 is a diagrammatic representation of a machine in the form of a computer system 60 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present invention includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 60 may include a processor 62 (e.g., a central processing unit (CPU), a graphics processing unit (GPU), or both), a main memory 64 and a static memory 66, which communicate with each other via a bus 68. The computer system 60 may further include a video display unit 70 (e.g., a liquid crystal display (LCD), a flat panel, a solid state display, or a cathode ray tube (CRT)). The computer system 60 may include an input device 72 (e.g., a keyboard), a cursor control device 74 (e.g., a mouse), a disk drive unit 76, a signal generation device 78 (e.g., a speaker or remote control) and a network interface device 80.

The disk drive unit 76 may include a machine-readable medium 82 on which is stored one or more sets of instructions (e.g., software 84) embodying any one or more of the methodologies or functions described herein, including those methods illustrated in herein above. The instructions 84 may also reside, completely or at least partially, within the main memory 64, the static memory 66, and/or within the processor 62 during execution thereof by the computer system 60. The main memory 64 and the processor 62 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present invention contemplates a machine readable medium containing instructions 84, or that which receives and executes instructions 84 from a propagated signal so that a device connected to a network environment 86 can send or receive voice, video or data, and to communicate over the network 86 using the instructions 84. The instructions 84 may further be transmitted or received over the network 86 via the network interface device 80.

While the machine-readable medium 82 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the invention is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method of monitoring network elements configured to support a number of customer virtual private networks (VPNs) provided for a number of customers, the method comprising:
associating network addresses and extended community numbers (ECNs) with the network elements;
associating the ECNs with a number of the customer VPNs;
generating a community list for at least a selected one of the customer VPNs, the community list specifying the network addresses for the network elements associated with the ECN of the selected customer VPN;
contacting the network elements specified in the community list based 11 on the network addresses associated therewith and extracting VPN interface information for the contacted network elements, the VPN interface information specifying a number of VPN interfaces associated with the network element and the customer associated with the VPN interfaces; and
determining an interface status for the interfaces associated with the selected customer.

2. The method of claim 1 wherein determining the interface statuses includes determining an interface address for the interfaces.

3. The method of claim 2 further comprising pinging the interface addresses and determining the interface statuses based on a response thereto.

4. The method of claim 3 wherein pinging the interface addresses includes testing connectivity of the interface with other interfaces associated with the selected VPN.

5. The method of claim 1 further comprising generating an interface status report for the interfaces associated with the selected customer VPN, the interface status report based on the interface statuses of the selected customer VPN.

6. The method of claim 5 further comprising determining interface statuses for multiple customer VPNs and generating a composite interface status report based on the interface statuses of the multiple customer VPNs.

7. The method of claim 6 wherein the composite interface status report indicates connectivity for at least one network element used to support different customer VPNs.

8. A computer readable medium for in monitoring network elements configured to support a number of customer virtual private networks (VPNs) provided for a number of customers, the computer readable medium includes instructions for:
associating network addresses and extended community numbers (ECNs) with the network elements;
associating the ECNs with a number of the customer VPNs;
generating a community list for at least a selected one of the customer VPNs, the community list specifying the network addresses for the network elements associated with the ECN of the selected customer VPN; and
determining an interface status for interfaces associated with the network elements identified in the community list.

9. The computer readable medium of claim 8 further comprising instructions for contacting the network elements specified in the community list based on the network addresses associated therewith and extracting VPN interface information for the contacted network elements, the VPN interface information specifying a number of VPN interfaces associated with the network element and the customer associated with the VPN interfaces so to facilitate determining the interface statuses for the selected customer.

10. The computer readable medium of claim 9 further comprising instructions for determining an interface address for the interfaces.

11. The computer readable medium of claim 10 further comprising instructions for pinging the interface addresses and determining the interface statuses based on a response thereto.

12. The computer readable medium of claim 11 further comprising instructions for testing connectivity of the interface with other interfaces associated with the selected VPN.

13. The computer readable medium of claim 9 further comprising instructions for generating an interface status report for the interfaces associated with the selected customer VPN, the interface status report based on the interface statuses of the selected customer VPN.

14. The computer readable medium of claim 13 further comprising instructions for determining interface statuses for multiple customer VPNs and generating a composite interface status report based on the interface statuses of the multiple customer VPNs.

15. The computer readable medium of claim 14 further comprising instructions for including connectivity for at least one network element used to support different customer VPNs in the composite interface status report.

16. An electronic system, the system comprising:
a number of customer virtual private networks (VPNs) provided for a number of customers;
a network monitoring tool configured for:
associating network addresses and extended community numbers (ECNs) with the network elements;
associating the ECNs with a number of the customer VPNs;
generating a community list for at least a selected one of the customer VPNs, the community list specifying the network addresses for the network elements associated with the ECN of the selected customer VPN; and
contacting the network elements specified in the community list based on the network addresses associated therewith and extracting VPN interface information for the contacted network elements, the VPN interface information specifying a number of VPN interfaces associated with the network element and the customer associated with the VPN interfaces.

17. The system of claim 16 wherein the tool is further configured for determining an interface status for the interfaces associated with the selected customer.

18. The system of claim 17 wherein the tool is further configured for determining the interface statuses includes determining an interface address for the interfaces and pinging the interface addresses such that the interface statuses are determined based on a response thereto.

19. The system of claim 16 wherein the tool is further configured for generating an interface status report for the interfaces associated with the selected customer VPN, the interface status report based on the interface statuses of the selected customer VPN.

20. The system of claim 19 wherein the tool is further configured for determining interface statuses for multiple customer VPNs and generating a composite interface status report based on the interface statuses of the multiple customer VPNs.
